(19) United States
(12) Patent Application Publication
(10) Pub. No.: US 2008/0179294 A1
(43) Pub. Date: Jul. 31, 2008

(54) GLASS COMPOSITIONS USEFUL FOR RIE STRUCTURING

(76) Inventors: Joseph S. HAYDEN, Clarks Summit, PA (US); Ulf Dahlmann, Gau-Odernheim (DE); Ulrich Fotheringham, Wiesbaden (DE); Wolfgang Pannhorst, Mainz (DE); Sally Pucilowski, Luzerne, PA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/017,780

(22) Filed: Jan. 22, 2008

Related U.S. Application Data
(60) Provisional application No. 60/881,469, filed on Jan. 22, 2007.

(51) Int. Cl. C03C 15/00; C03C 3/253

(52) U.S. Cl. 216/97; 501/42

(57) ABSTRACT

A glass composition suitable for reactive ion etching.

This application claims the benefit of the filing date of U.S. Provisional Application Serial No. 60/881,469, filed Jan. 22, 2007, which is incorporated by reference herein.

As the size and weight of consumer optical systems, such as compact camera employing CCD and CMOS detectors, has been decreasing; and the market volume for these devices has been greatly expanding; it has become increasingly important to develop manufacturing technologies that have the potential to form optical components, such as lenses and diffractive optical elements, on a smaller spatial scale, for example on the order of sub-micron to 100 micron scale structures, depending on the intended use. Such small spatial scale optical components, when prepared in a format of an array of optical components in a wafer style format, are attractive in that they can be used in the manufacturing of consumer optical devices, for example cell phone camera assemblies, using similar manufacturing technologies as employed successfully in the integrated circuit industry for production of memory chips, processors and other electronic components. This thus allows increased manufacturing rates using automated production lines and lowers final costs for produced devices. One technique used to produce optical components on a sub-micron to 100 um scale is reactive ion etching (RIE). RIE techniques are currently used for fine patterning of fused silica, e.g., in the production of diffraction gratings, lens arrays, wave guides, etc.

There is a need for multi-component glasses that offer a wide range of optical and physical properties that can also be structured by reactive ion etching. Conventionally, glass designers have been limited to use of fused silica, which forms volatile fluorides or chlorides under standard conditions of 1 atmosphere pressure and nominally room temperature. In this invention, we disclose an extension to this list of elements by taking advantage of the realization that RIE processing can be conducted at low pressure and with sample temperatures held above room temperature. In this way, the number of glass components available to the glass designer has been extended, opening up new potential property sets for RIE application.

This invention relates to glasses having only those components that form volatile fluorides or chlorides at reduced pressure and elevated temperatures that can be encountered during reactive ion etching.

Such glasses thus provide to the glass designer an expanded list of components compared to the prior art, extending the potential range of optical and physical properties that can now be offered by materials that have been structured by RIE. Examples include opportunity to increase refractive index to, or to more than, about 1.7 units and decrease in Abbe number (a measure of index dispersion with wavelength) to less than or equal to about 50 units. More preferably, the refractive index is ≧1.75 and the Abbe number is ≦45 units. The glasses can now potentially also have a thermal expansion as close as possible to the expansion of common semiconductors, for example an expansion of about ≦7 ppm/K, or more preferably of ≦5 ppm/K. In contrast, the expansion of fused silica at about 0.5 ppm/K is much lower than common semiconductors. Matching the thermal expansion to common semiconductors greatly assists in the manufacturing of optical devices using integrated circuit manufacturing technologies since the optical assemblies can now be directly bonded to the semiconductor, further shrinking the potential size of such optical devices. By offering a range of refractive index and Abbe number values, optical designers can now have the freedom to apply achromatic and apochromatic lens designs as used successfully in the past for larger optical instruments such as SLR cameras, microssopic imaging systems, etc.

The present invention is based on the determination that the pressure in a RIE chamber can be as low as a few 10's of mtorr (1 mtorr=1.33 ubar=0.13 Pa). This is true even in the glow discharge area where the reactive plasma is formed and used to etch the glass target. Also, it was determined that a typical sample temperature is actually as high as about 150 C, even when the sample is actively cooled.

Thus, a formed volatile fluoride or chloride with a vapor pressure of perhaps >40 mtorr or about 50 ubar (0.005 kPa) at 150° C. can be removed from a glass surface during the RIE process. Allowing for a correction of the boiling point variation with pressure, if a element forms a fluoride or chloride product with a boiling point of 560° C. at 1 atmosphere it is volatile in the RIE chamber under the operating conditions of a few 10's of mtorr pressure and a sample temperature of 150° C. or higher.

Moreover, where RIE systems are operated at pressures 10× higher or with colder glass targets of about 100° C., values of vapor pressure of 0.4 torr or 0.5 mbar (0.05 kPa) and temperature of 100 C can be used as a criteria for element selection. Again correcting for boiling point reduction with reduction in pressure, fluoride or chloride RIE product with a boiling point of about 380° C. at 1 atmosphere is volatile in the RIE chamber at these revised conditions.

In reactive ion etching (RIE), a glass or silicon sample target is placed in a reactor system and the system is initially evacuated. Following this, a reactive gas, usually a gas containing fluorine or chlorine or their compounds with other elements is introduced into the chamber. A radio frequency (RF) discharge is created in the vicinity of the target, creating a highly reactive plasma of F and/or Cl atoms which then react with the constituents making up the composition of the glass target. As a result, elements in the target, for example Si, are converted to their fluorides or chlorides, for example SiF, which in turn if they are sufficiently volatile are removed from the reaction vessel by the continual action of a pumping system. RIE techniques are disclosed in, e.g., U.S. Pat. Nos. 5,728, 619; T101,302; 4,983,253; 4,287,661; 4,473,436; and 4,479,850 and in James W. Mayer and S. S. Lau, Electronic Materials Science for Integrated Circuits in Si and GaAs, which are incorporated by reference in their entireties herein.

If portions of the glass have been partially protected with a mask made from a material not reactive with fluorine or chlorine ions, only the unprotected regions are chemically attacked or etched. In this way, microscopic features can be created on the glass surface. Such a masked technology allows the construction of surface relief diffraction gratings, lens arrays, waveguides, etc.

Until now, when designing a glass composition for use in RIE structuring, the glass developer has been limited to the selection of those elements that form volatile fluorides or chlorides, selected on the basis of comparing the boiling point of the corresponding halide compounds at room temperature. An element forming a fluoride or chloride compound with a boiling point less than 20° C. at one atmosphere of pressure was considered to be volatile. Such elements were desirable to be incorporated into the glass structure since they would be quickly removed from the glass target surface upon formation, allowing more rapid etching of surface features. Increased etching speed in turn allows structures with finer details and more vertical sidewalls to be etched since the deterioration of such features is increased with increasing reaction time.

Thus, the present application has extended the list of desirable elements in a RIE glass by considering that the RIE processing can be done at reduced pressures and with the sample at elevated temperatures. Interaction with multiple sites performing reactive ion processing of materials, it was determined that even in the reaction zone that contains the reactive gas, pressures are typically only a few 10's of mtorr (1 mtorr=1.33 ubar=0.13 Pa). In addition, it was found that the glass targets are inherently heated by the RIE process, and that even with aggressive the cooling glass targets are generally at 150° C.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever. In the foregoing and in the following examples, all temperatures are set forth uncorrected in degrees Celsius and, all parts and percentages are by weight, unless otherwise indicated.

### EXAMPLES

Tables on the following pages detail example compositions of the present application. Listed with each composition are the predicted values for index, nd, Abbe number (Vd), density, and thermal expansion (CTE from 20 C to 300 C).

TABLE 1
Example Compositions of the Present Application

| Example | | | | | |
|---|---|---|---|---|---|
| RIE-10 | RIE-11 | RIE-12 | RIE-13 | RIE-14 | RIE-15 |

Composition in Mol %

| | | | | | | |
|---|---|---|---|---|---|---|
| Oxide | | | | | | |
| WO₃ | 76.00 | 71.00 | 63.50 | 38.00 | 49.40 | 41.80 |
| Nb₂O₅ | 24.00 | 19.00 | 11.50 | 12.00 | 15.60 | 13.20 |
| GeO₂ | 0.00 | 0.00 | 0.00 | 0.00 | 10.00 | 20.00 |
| B₂O₃ | 0.00 | 10.00 | 25.00 | 50.00 | 25.00 | 25.00 |

Composition in wt %

| | | | | | | |
|---|---|---|---|---|---|---|
| WO₃ | 73.42 | 74.12 | 75.42 | 56.91 | 62.29 | 56.90 |
| Nb₂O₅ | 26.58 | 22.74 | 15.66 | 20.60 | 22.55 | 20.60 |
| GeO₂ | 0.00 | 0.00 | 0.00 | 0.00 | 5.69 | 12.28 |
| B₂O₃ | 0.00 | 3.13 | 8.92 | 22.49 | 9.47 | 10.22 |

Modeled Properties

| | | | | | | |
|---|---|---|---|---|---|---|
| Property | | | | | | |
| nd | 2.26207 | 2.19423 | 2.0846 | 1.93935 | 2.06057 | 2.01023 |
| n_{F}-n_{C} | 0.054310 | 0.049777 | 0.042450 | 0.032824 | 0.040932 | 0.037622 |
| Vd | 23.24 | 23.99 | 25.55 | 28.62 | 25.91 | 26.85 |
| Density | 6.83 | 6.50 | 5.95 | 4.60 | 5.56 | 5.35 |
| CTE (20-300) | 70.86 | 68.17 | 63.81 | 54.72 | 61.42 | 59.61 |

TABLE 2
Example Compositions of the Present Application

| Example | | | | | |
|---|---|---|---|---|---|
| RIE-16 | RIE-17 | RIE-18 | RIE-19 | RIE-20 | RIE-21 |

Composition in Mol %

| | | | | | | |
|---|---|---|---|---|---|---|
| Oxide | | | | | | |
| WO₃ | 34.20 | 19.00 | 30.40 | 22.80 | 15.20 | 7.50 |
| Nb₂O₅ | 10.80 | 6.00 | 9.60 | 7.20 | 4.80 | 7.50 |
| GeO₂ | 30.00 | 0.00 | 10.00 | 20.00 | 30.00 | 10.00 |
| B₂O₃ | 25.00 | 75.00 | 50.00 | 50.00 | 50.00 | 75.00 |

Composition in wt %

| | | | | | | |
|---|---|---|---|---|---|---|
| WO₃ | 50.58 | 39.26 | 49.89 | 41.39 | 30.86 | 17.39 |
| Nb₂O₅ | 18.31 | 14.21 | 18.06 | 14.98 | 11.17 | 19.94 |
| GeO₂ | 20.01 | 0.00 | 7.40 | 16.38 | 27.48 | 10.46 |
| B₂O₃ | 11.10 | 46.53 | 24.64 | 27.25 | 30.49 | 52.22 |

Modeled Properties

| | | | | | | |
|---|---|---|---|---|---|---|
| Property | | | | | | |
| nd | 1.95478 | 1.75938 | 1.883671 | 1.82238 | 1.75461 | 1.71697 |
| n_{F}-n_{C} | 0.033976 | 0.020841 | 0.029156 | 0.025119 | 0.020655 | 0.018086 |
| Vd | 28.10 | 36.44 | 30.31 | 32.74 | 36.54 | 39.64 |
| Density | 5.11 | 3.35 | 4.34 | 4.05 | 3.74 | 2.96 |
| CTE (20-300) | 57.60 | 45.72 | 52.60 | 50.26 | 47.68 | 43.11 |

TABLE 3
Example Compositions of the Present Application

| Example | | | | |
|---|---|---|---|---|
| RIE-22 | RIE-23 | RIE-24 | RIE-25 | RIE-26 |

Composition in Mol %

| | | | | | |
|---|---|---|---|---|---|
| Oxide | | | | | |
| WO₃ | 5.00 | 5.00 | 5.00 | 5.00 | 3.00 |
| Nb₂O₅ | 5.00 | 5.00 | 5.00 | 5.00 | 5.00 |
| GeO₂ | 20.00 | 40.00 | 50.00 | 55.00 | 57.00 |
| B₂O₃ | 70.00 | 50.00 | 40.00 | 35.00 | 35.00 |

Composition in wt %

| | | | | | |
|---|---|---|---|---|---|
| WO₃ | 12.26 | 11.42 | 11.04 | 10.86 | 6.67 |
| Nb₂O₅ | 14.06 | 13.09 | 12.65 | 12.45 | 12.75 |
| GeO₂ | 22.13 | 41.21 | 49.79 | 53.87 | 57.2 |
| B₂O₃ | 51.55 | 34.29 | 26.52 | 22.82 | 23.38 |

Modeled Properties

| | | | | | |
|---|---|---|---|---|---|
| Property | | | | | |
| nd | 1.67845 | 1.69796 | 1.70885 | 1.71461 | 1.70192 |
| n_{F}-n_{C} | 0.015557 | 0.016954 | 0.017733 | 0.018145 | 0.017316 |
| Vd | 43.61 | 41.17 | 39.97 | 39.38 | 40.54 |
| Density | 2.90 | 3.34 | 3.58 | 3.71 | 3.63 |
| CTE | 42.28 | 44.81 | 46.23 | 46.98 | 46.36 |
| (20-300) | | | | | |

TABLE 4
Example Compositions of the Present Application

| | | |
|---|---|---|
| Oxide | RIE-27 | RIE-28 |

Composition in Mol %

| | | |
|---|---|---|
| GeO₂ | | 50.0 |
| B₂O₃ | 85.0 | 40.0 |
| TiO₂ | 5.7 | 3.8 |
| Nb₂O₅ | 9.3 | 6.2 |

Composition in Wt %

| | | |
|---|---|---|
| GeO₂ | | 52.47 |
| B₂O₃ | 66.90 | 27.94 |
| TiO₂ | 5.15 | 3.05 |
| Nb₂O₅ | 27.95 | 16.54 |

Modeled Properties

| | | |
|---|---|---|
| index | 1.71690 | 1.171654 |
| nF-nC | 0.018425 | 0.018554 |
| Vd | 38.91 | 38.62 |
| CTE | 41.25 | 45.65 |
| Density | 2.54 | 3.40 |

The entire disclosure[s] of all applications, patents and publications, cited herein and of German patent application No. 10 2005 034 785.1, filed Jul. 21, 2005 are incorporated by reference herein. This application also claims the benefit of the filing date of U.S. Provisional Application Ser. No. 60/881,469, filed Jan. 22, 2007, which is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

We claim:

1.) A glass comprising at least two of the following: B, C, N, Al, Si, P, S, Ti, Ge, As, Se, Zr, Nb, Mo, Ru, Rh, Sn, Sb, Te, Ta, W, Re, Ir, Pt, Hg, Pb, Bi, Yb, Lu, Th, U or Np, said elements forming volatile fluoride or chlorides with vapor pressure 40 mtorr at 150° C., said glass being suitable for reactive ion etching.

2.) A glass according to claim 1, comprising at least two of the following: B, C, N, Al, Si, P, S, Ti, Ge, As, Se, Zr, Nb, Mo, Ru, Rh, Sn, Sb, Te, Ta, W, Re, Ir, Pt, Hg, Pb, Bi, Yb, Lu.

3.) A glass according to claim 1, said elements forming volatile fluorides or chlorides with a vapor pressure >400 mtorr at 100° C.

4.) A glass according to claim 3, comprising at least two of the following: B, C, N, Al, Si, P, S, Ti, Ge, As, Se, Zr, Nb, Mo, Ru, Rh, Sn, Sb, Te, Ta, W, Re, Ir, Pt, Hg, Pb, Bi, Yb, or Lu.

5.) A glass of claim 2, comprising W, Nb, B and Ge.

6.) A glass of claim 2, comprising Ti, Nb, B and Ge.

7.) A glass of claim 4, comprising W, Nb, B and Ge.

8.) A glass of claim 4, depending on embodiment 4, comprising Ti, Nb, B and Ge.

9.) A glass of claim 1, comprising in mol %,

| | |
|---|---|
| WO₃ | 3-76 |
| Nb₂O₅ | 4-27 |
| GeO₂ | 0-58 |
| B₂O₃ | 0-75 |

10.) A glass of claim 1, comprisinq, in mol %,

| | |
|---|---|
| GeO₂ | 0-53 |
| B₂O₃ | 27-85 |
| TiO₂ | 3-6 |
| Nb₂O₅ | 6-28 |

11.) A method of reactive ion etching of a glass substrate, comprising reacting said substrate with a reactive plasma containing fluorine and/or chlorine atoms so as to convert elements within the glass to fluorides or chlorides which can then be removed, wherein said elements form volatile fluorides or chlorides with a vapor pressure >40 mtorr at 150° C., and are at least two of B, C, N, Al, Si, P, S, Ti, Ge, As, Se, Zr, Nb, Mo, Ru, Rh, Sn, Sb, Te, Ta, W, Re, Ir, Pt, Hg, Pb, Bi, Yb, Lu, Th, U or Np.

12.) A method according to claim 11, wherein the elements form volatile fluorides or chlorides with a vapor pressure >40 mtorr at 100° C.

13.) A method according to claim 11, wherein the elements are at least two of B, C, N, Al, Si, P, S, Ti, Ge, As, Se, Zr, Nb, Mo, Ru, Rh, Sn, Sb, Te, Ta, W, Re, Ir, Pt, Hg, Pb, Bi, Yb, Lu.

14.) A method according to claim 13, wherein the elements form volatile fluorides or chlorides with a vapor pressure >40 mtorr at 100° C.

15.) A glass according to claim 1, wherein the glass is not one consisting of, in mol %,
40-70% SiO₂
5-20% B₂O₃
5-20% P₂O₅
0-30% GeO₃
0-10% W₂O₃
0-10% As₂O₃
0-5% Yb₂O₃
0-5% Lu₂O₃

16.) A glass according to claim 9, wherein the glass is not one consisting of, in mol %,
40-70% SiO₂
5-20% B₂O₃
5-20% P₂O₅
0-30% GeO₃
0-10% W₂O₃
0-10% As₂O₃
0-5% Yb₂O₃
0-5% Lu₂O₃

17.) A glass according to claim 10, wherein the glass is not one consisting of, in mol %,
40-70% SiO₂
5-20% B₂O₃
5-20% P₂O₅
0-30% GeO₃
0-10% W₂O₃
0-10% As₂O₃
0-5% Yb₂O₃
0-5% Lu₂O₃

18.) A glass according claim 15, wherein the glass is not one consisting of, in mol %

| | |
|---|---|
| SiO₂ | 40-70 |
| GeO₂ | 0-30 |
| B₂O₃ | 5-20 |
| P₂O₅ | 5-20 |
| As₂O₃ | 0-10 |
| WO₃ | 0-15 |
| Yb₂O₃ | 0-5 |
| Lu₂O₃ | 0-5 |

19.) A glass claim 18, wherein the glass is not one consisting of, in mol %

| | |
|---|---|
| SiO₂ | 40-65 |
| GeO₂ | 3-30 |
| B₂O₃ | 10-18 |
| P₂O₅ | 10-18 |

20.) A glass of claim 15, wherein the glass is not:

| | | mol % |
|---|---|---|
| (a) | SiO₂ | 40 |
| | GeO₂ | 30 |
| | B₂O₃ | 15 |
| | P₂O₅ | 15 |
| (b) | SiO₂ | 50 |
| | GeO₂ | 20 |
| | B₂O₃ | 15 |
| | P₂O₅ | 15 |
| (c) | SiO₂ | 60 |
| | GeO₂ | 10 |
| | B₂O₃ | 15 |
| | P₂O₅ | 15 |
| (d) | SiO₂ | 60 |
| | GeO₂ | 20 |
| | B₂O₃ | 10 |
| | P₂O₅ | 10 |
| (e) | SiO₂ | 50 |
| | GeO₂ | 30 |
| | B₂O₃ | 10 |
| | P₂O₅ | 10 |
| (f) | SiO₂ | 70 |
| | B₂O₃ | 15 |
| | P₂O₅ | 15 |
| (g) | SiO₂ | |
| | B₂O₃ | |
| | P₂O₅ | |
| | NO₃ | |
| (h) | SiO₂ | 60 |
| | GeO₂ | 7 |
| | B₂O₃ | 15 |
| | P₂O₅ | 15 |
| | A₂O₃ | 3 |
